(19) United States
(12) Patent Application Publication
(10) Pub. No.: US 2004/0013430 A1
(43) Pub. Date: Jan. 22, 2004

(54) Wavelength monitor and motor driving and controlling device

(76) Inventors: Keisuke Asami, Shinshiro-shi (JP); Hironori Takai, Hamamatsu-shi (JP); Yasuhiro Tanaka, Hamamatsu-shi (JP)

Correspondence Address: FISH & RICHARDSON P.C., 45 ROCKEFELLER PLAZA, SUITE 2800, NEW YORK, NY, 10111, US

(21) Appl. No.: 10/620,172

(22) Filed: Jul. 15, 2003

(30) Foreign Application Priority Data
Jul. 19, 2002 (JP) P. 2002-210378

(51) Int. Cl. H04J 14/06

(52) U.S. Cl. 398/65

(57) ABSTRACT

A wavelength monitor capable of highly accurately and highly stably detecting a wavelength variation of a tunable laser source, and a motor control device for easily and highly precisely driving a motor which is wavelength varying means, by using the wavelength monitor. The wavelength monitor is a wavelength monitor for detecting a wavelength variation of light outputted from a tunable laser source, and includes a first polarizer for forming light outputted from the tunable laser source into a linearly polarized beam with a polarizing angle of 45 degrees, a beam splitter for dividing a beam transmitted through the polarizer into two beams, first reflecting means for reflecting one of the two beams divided by the beam splitter and causing the reflected one to again enter the beam splitter, a wave plate for performing λ/8 phase-shifting, the wave plate allowing the other of the two beams divided by the beam splitter to double-pass through the wave plate by being reflected by a second reflecting plate and causing the other to enter the beam splitter, and a polarizing beam splitter for dividing output light recombined by the beam splitter into two mutually perpendicular components and outputting the respective components to the first and second photodetectors.

### BACKGROUND OF THE INVENTION

1 Field of the Invention

The present invention relates to a wavelength monitor for detecting the wavelength of light outputted from a tunable laser source.

2. Description of the Related Art

In a related-art type of tunable laser source, the accuracy of the wavelength of the light source is determined by the positioning reproducibility of a motor used as wavelength varying means and that of a motor periphery driving part, and a high-performance motor which is extremely expensive needs to be used when a highly accurate tunable laser source is to be obtained.

In addition, even if an expensive motor is used, the actual accuracy of wavelength of the light source is not proportional to the precision of the motor, owing to backlash, stick-slip or the like in the entire driving part.

For this reason, wavelength monitors capable of highly accurately detecting light-source wavelength variations themselves have received a great deal of attention.

As disclosed in JP-A-10-339668, Application No. 2001-008589 or the like, there is a related-art wavelength monitor capable of compatibly realizing high resolution and a wide wavelength band by obtaining two periodical amplitude signals which are π/2 phase-shifted from each other. However, such a related-art wavelength monitor has the problem that a large amplitude is difficult to obtain and a temporally stable waveform is difficult to obtain.

JP-A-10-339668 aims to “provide an inexpensive device for automatically adjusting the wavelength of an optical signal of a laser light source without being greatly affected by harmful influences under conditions experienced in practice”, and discloses “an optical wavemeter for measuring the wavelength of a first light beam, comprising: a first optical part disposed within the first light beam or in part thereof and constructed to generate a second light beam having a first optical power determined by the wavelength of the first light beam; a first power detector for detecting the optical power of the second light beam; and a first allocator for allocating a wavelength to the detected first optical power on the basis of the dependent relationship of the optical power of the second light beam generated by the first optical part with respect to the wavelength of the first light beam to be measured”.

Application No. 2001-008589 aims to “provide a wavelength monitor for measuring the wavelength of a light source oscillating in a single mode, in which wavelength monitor a phase difference of π/2 is generated between the strengths of two beams of interference light without using an optical member having special specifications and the phase difference can be adjusted after each optical member is fixed, and discloses “a wavelength monitor comprising: a Michelson interferometer type of optical system having an optical element for converting light entering from a light input part into parallel light, a first beam splitter for receiving the parallel light from the optical element and dividing the parallel light into two beams, and first and second reflectors for respectively reflecting the two beams into which the parallel light has been divided by the first beam splitter, the optical system having an interference fringe generating unit for inclining the wave front of reflected light from the first and second reflectors which has been recombined by the first beam splitter and has exited therefrom, and generating interference fringes in the distribution of light strength in a beam plane of interference light; a second beam splitter for dividing the interference light that has been recombined by the first beam splitter and has exited in a direction different from an entrance side of the first beam splitter; first and second photodetectors for respectively receiving two beams into which the interference light has been divided by the second beam splitter; a first slit disposed in the front of the first photodetector; a second slit disposed in the front of the second photodetector; and a signal processing unit for performing digital processing on light strengths sent from the first and second photodetectors” (claim 1).

In addition, control of a motor (such as a servo motor) which constitutes a tunable laser source has heretofore been executed on the basis of the detected output of the wavelength monitor by means of a construction of the type shown in FIG. 5 or 6.

FIG. 5 is a block diagram showing one example of a construction for controlling a motor of a light source part according to a related art.

A motor (such as a servo motor) 52 which is wavelength varying means for a light source part 51 of a tunable laser source is controlled by a motor control circuit 59 according to the output of a comparing circuit 58.

The output from an encoder 53 connected to the motor 52 is applied to one input of the comparing circuit 58 via a frequency multiplier 56 and a feedback counter 57, while the output from a pulse generating circuit 61 that responds to a control signal sent from a control CPU 64 is applied to the other input of the comparing circuit 58 as a comparing input via a pulse counter 60. In this manner, a feedback system is formed.

The output light from the tunable laser source part 51 is divided into two beams by a beam splitter 54, and one of the two beams is fed back to an LD control circuit 62 via a power monitor 55 formed by a photodiode or the like, and power control is performed so that the power of the output light from the tunable laser source part 51 becomes a set value sent from the CPU 64.

Further, the tunable laser source part 51 is temperature-controlled by a temperature control circuit 63 so that the temperature of the light source part 51 becomes a set value sent from the CPU 64.

FIG. 6 is a block diagram showing another example of a construction for controlling a motor of a light source part according to a related art.

The motor (such as a servo motor) 52 which is wavelength varying means for the light source part 51 of a tunable laser source is controlled by the motor control circuit 59 according to the output of the comparing circuit 58.

The output from the encoder 53 connected to the motor 52 is applied to one input of the comparing circuit 58 via the frequency multiplier 56 and the feedback counter 57, while the output from the pulse generating circuit 61 that responds to a control signal sent from the control CPU 64 is applied to the other input of the comparing circuit 58 as a comparing input via the pulse counter 60. In this manner, a feedback system is formed.

The output light from the tunable laser source part 51 is divided into two beams by the beam splitter 54, and one of the two beams is fed back to the LD control circuit 62 via the power monitor 55 formed by a photodiode or the like, and power control is performed so that the power of the output light from the tunable laser source part 51 becomes a set value sent from the CPU 64.

In addition, the tunable laser source part 51 is temperature-controlled by the temperature control circuit 63 so that the temperature of the light source part 51 becomes a set value sent from the CPU 64.

Further, in the construction shown in FIG. 6, the output light from the tunable laser source part 51 is divided into two beams by another beam splitter 67, and one of the two beams is fed back to the CPU 64 via a wavelength monitor 65 and a wavelength computing circuit 66, thereby correcting a control signal (set value) to be given to the pulse generating circuit 61 by setting and correction from the CPU 64.

FIG. 7 is a block diagram showing another example of a construction for controlling a motor of a light source part according to a related art.

A stepping motor 52 which is wavelength varying means for the light source part 51 of a tunable laser source is controlled by the motor control circuit 59 according to the output of the pulse counter 60.

The output light from the light source part 51 is divided into two beams by the beam splitter 67 and one of the two beams is fed back to the CPU 64 via the wavelength monitor 65 and the wavelength computing circuit 66, and a setting correction from the CPU 64 is given to the pulse counter 60 via the pulse generating circuit 61.

The output light from the tunable laser source part 51 is divided into two beams by the beam splitter 54, and one of the two beams is fed back to the LD control circuit 62 via the power monitor 55 formed by a photodiode or the like, and power control is performed so that the power of the output light from the tunable laser source part 51 becomes a set value sent from the CPU 64.

In addition, the tunable laser source part 51 is temperature-controlled by the temperature control circuit 63 so that the temperature of the light source part 51 becomes a set value sent from the CPU 64.

In the case of the stepping motor shown in FIG. 7, although its construction is inexpensively realized, there is the problem that time is taken to correct the wavelength of output light, similarly to the motor shown in FIG. 6, and the operation of the motor is not smooth.

In addition, if the linearity of the stepping motor is inferior, there is the problem that one cycle of correction cannot reach a target and plural cycles of correction must be performed.

In general, there are wavelength monitors of the optical filter type in which its transmissivity varies in proportion to a variation in wavelength or wavelength monitors of the Fabry-Perot etalon type in which a periodical amplitude signal can be easily obtained. The optical filter type cannot easily achieve high resolution, while the etalon type cannot easily detect over a wide wavelength band.

Furthermore, even if the deviation between a set wavelength and an actually measured wavelength is to be corrected on the basis of a signal obtained through such a wavelength monitor, a driving part is required to have an extremely high linearity for the purpose of instantaneously correcting a deviation with correction pulses transmitted to the motor, so that it is difficult to make reliable correction with an inexpensive mechanism.

In the construction shown in FIG. 5, a closed loop control system in which the encoder 53 is used to detect the mechanical position of the motor 52 is formed, but since the output light of the tunable laser source 51 is not directly detected, an open loop is formed with respect to the output light. Accordingly, there is the problem that even if no deviation occurs in the detected signal of the encoder 53, a deviation may occur in an output wavelength.

In the construction shown in FIG. 6, a closed loop control system in which the encoder 53 is used to detect the mechanical position of the motor 52 is formed, and the output light of the tunable laser source 51 is detected by the wavelength monitor 65 and is fed back to the pulse generating circuit 61. Accordingly, since the wavelength computing circuit 66 and the CPU 64 are used, there is the problem that time is taken to correct a wavelength and the operation of the motor 52 is not smooth.

### SUMMARY OF THE INVENTION

An object of the invention is to provide a wavelength monitor capable of highly accurately and highly stably detecting a wavelength variation of a tunable laser source, and to provide a motor control device for easily and highly precisely driving a motor which is wavelength varying means, by using the wavelength monitor.

To solve the above-described problems, the invention provides a wavelength monitor for detecting a wavelength variation of light outputted from a tunable laser source, the wavelength monitor including: a first polarizer for forming light outputted from the tunable laser source into a linearly polarized beam with a polarizing angle of 45 degrees; a beam splitter for dividing a beam transmitted through the polarizer into two beams; first reflecting means for reflecting one of the two beams divided by the beam splitter and causing the reflected one to again enter the beam splitter; a wave plate for performing λ/8 phase-shifting, the wave plate allowing the other of the two beams divided by the beam splitter to double-pass through the wave plate by being reflected by a second reflecting plate and causing the other to enter the beam splitter; and a polarizing beam splitter for dividing output light recombined by the beam splitter into two mutually perpendicular components, and outputting the respective components to first and second photodetectors.

The invention also provides a wavelength monitor for detecting a wavelength variation of light outputted from a tunable laser source, the wavelength monitor including: a first polarizer for forming light outputted from the tunable laser source into a linearly polarized beam with a polarizing angle of 45 degrees; a beam splitter for dividing a beam transmitted through the polarizer into two beams; a polarizing beam splitter and first and second reflecting means for recombining the beams divided by the beam splitter, separating the recombined beams into two mutually perpendicular polarized components, and outputting the respective components to first and second photodetectors as output light; and a wave plate for performing λ/4 phase-shifting, the wave plate being inserted in either one of optical paths divided by the beam splitter.

The invention also provides a wavelength monitor for detecting a wavelength variation of light outputted from a tunable laser source, the wavelength monitor including: a first polarizer for forming light outputted from the tunable laser source into a linearly polarized beam with a polarizing angle of 45 degrees; a delay unit for vectorially decomposing light outputted from the first polarizer and delaying one of components with respect to the other; a beam splitter for dividing light passed through the delay unit into two beams; a first photodetector for receiving one of the two beams divided by the beam splitter via a λ/4 phase-shifting wave plate and a second polarizer; and a second photodetector for receiving the other of the two beams divided by the beam splitter via a third polarizer.

The invention also provides a construction in which a polarization maintaining fiber (PMF) is used in place of the first polarizer.

Incidentally, it is far more preferable that the portion of the first polarizer be replaced with a combination of a polarization maintaining fiber (PMF) and a polarizer (POL). (In the case of only a polarizer (a combination of a single mode fiber (SMF) and a polarizer), transmission power easily fluctuates, whereas in the case of only a polarization maintaining fiber (PMF), transmission power is stable but a polarized state easily fluctuates.)

The invention also provides a construction in which an additional beam splitter is inserted after the first polarizer to execute power-monitoring of divided beams outputted from the additional beam splitter.

The invention also provides a motor control device for driving a motor which is means for varying a wavelength of output light of a tunable laser source, the motor control device including: a wavelength monitor for monitoring part of the output light of the tunable laser source and detecting wavelength information; a frequency multiplier for converting two π/2 phase-shifted periodical amplitude signals sent from the wavelength monitor into a digital signal corresponding to a wavelength of the output light; and a comparing circuit for finding a deviation between an output of the frequency multiplier and a command value, the motor control device driving and controlling the motor according to a comparison deviation outputted from the comparing circuit.

The invention also provides a construction in which the tunable laser source is controlled to a constant level of power by power-monitoring for monitoring power of the output light of the tunable laser source.

### BRIEF DESCRIPTION OF THE DRAWINGS

The invention will become more readily appreciated and understood from the following detailed description of a preferred embodiment of the invention when taken in conjunction with the accompanying drawings, in which:

FIGS. 1A and 1B are views showing the construction of a first embodiment of a wavelength monitor according to the invention;

FIG. 2 is a view showing the construction of a second embodiment of a wavelength monitor according to the invention;

FIG. 3 is a view showing the construction of a third embodiment of a wavelength monitor according to the invention;

FIG. 4 is a block diagram showing the construction of a motor control circuit of a tunable laser source according to the invention;

FIG. 5 is a block diagram showing a first construction of a motor control circuit of a tunable laser source according to a related art;

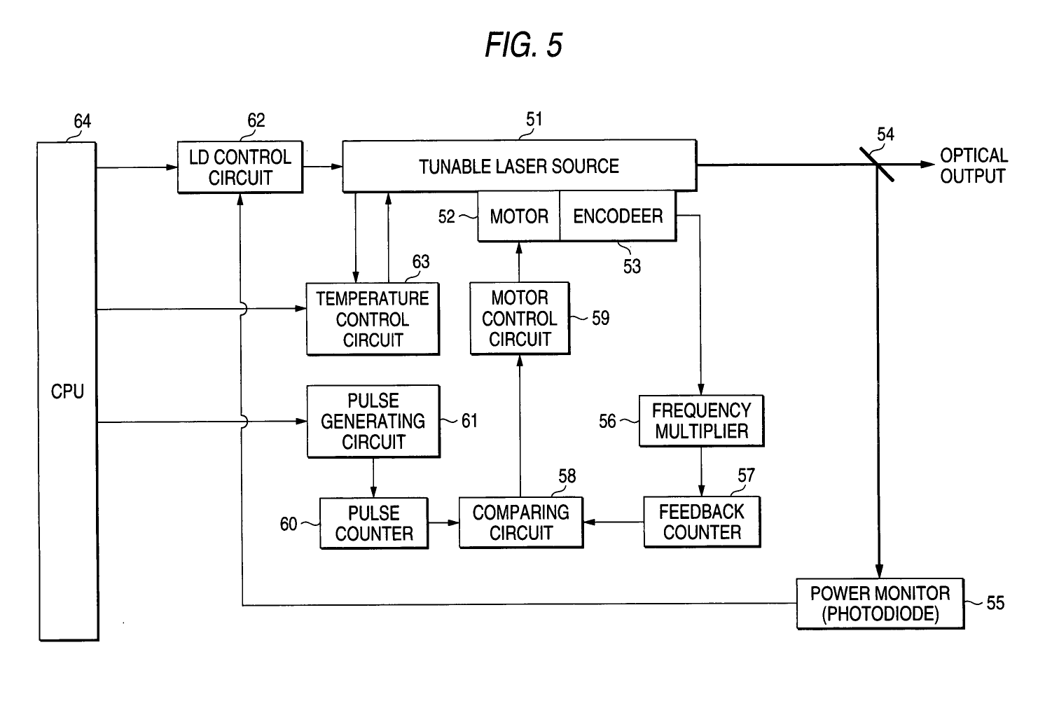

FIG. 6 is a block diagram showing a second construction of a motor control circuit of a tunable laser source according to a related art; and

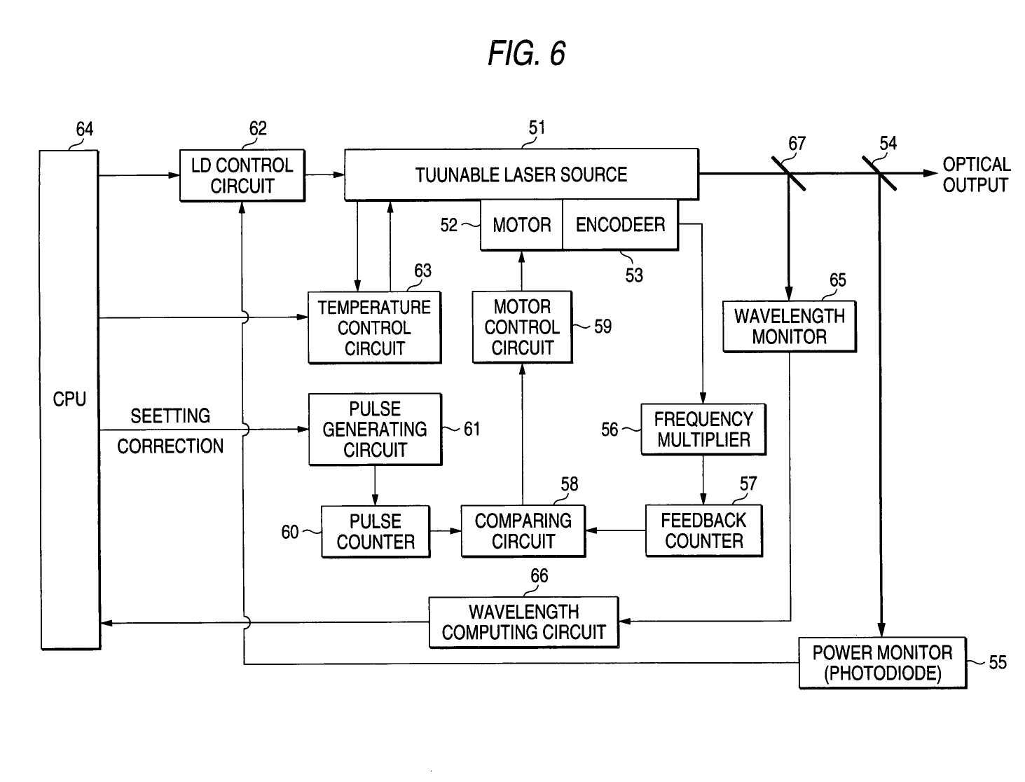

FIG. 7 is a block diagram showing a third construction of a motor control circuit of a tunable laser source according to a related art.

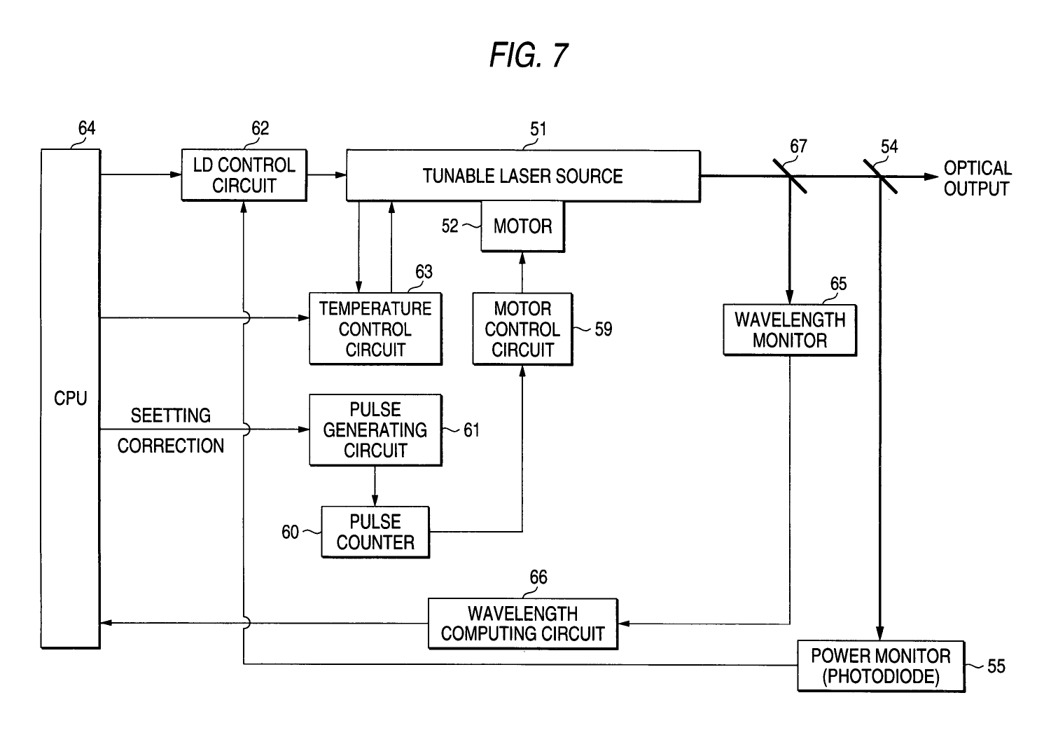

### DETAILED DESCRIPTION OF THE INVENTION

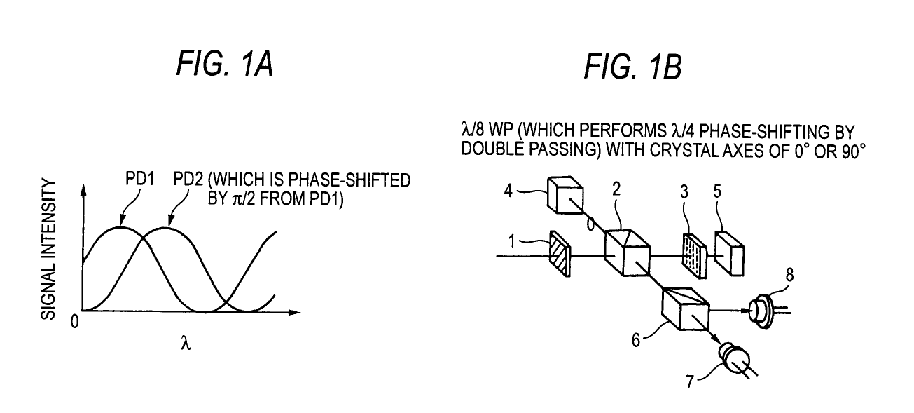

The construction of a first embodiment of a wavelength monitor according to the invention will be described below with reference to FIG. 1B.

In FIG. 1B, reference numeral 1 denotes a 45-degree polarizer (POL1), reference numeral 2 denotes a beam splitter (BS1) which is a beam dividing element, reference numeral 3 denotes a λ/8 wave plate (λ/8 WP), reference numeral 4 denotes a first mirror (MR1), reference numeral 5 denotes a second mirror (MR2), reference numeral 6 denotes a polarizing beam splitter (PBS1), reference numeral 7 denotes a first photodetector (PD1), and reference numeral 8 denotes a second photodetector (PD2).

Otherwise, the polarizer (POL1) 1 may also be replaced with a polarization maintaining fiber (PMF) (45°) or a combination of a polarization maintaining fiber (PMF) and a polarizer (POL).

Otherwise, another beam splitter (BS) may also be inserted between the polarizer (POL1) 1 and the beam splitter (BS1) 2 so that a divided output from the beam splitter (BS) is power-monitored through a photodetector (PD).

The beam splitter (BS1) 2 is desirably of a non-polarizing type.

In the above-described construction, light exiting from a tunable laser source which is not shown is formed into a linearly polarized beam with a polarizing angle of 45 degrees by the polarizer (POL1) 1, and the beam transmitted through the polarizer (POL1) 1 is divided into two beams by the beam dividing element (beam splitter (BS1)) 2. One of the two beams is passed through the λ/8 wave plate λ/8 WP) 3 and reflected by the second mirror (MR2) 5, and is again passed through the λ/8 wave plate (λ/8 WP) 3 and recombined by the beam diving element (beam splitter (BS1)) 2.

This beam is λ/8 phase-shifted in wavelength because the λ/8 wave plate (λ/8 WP) 3 is inserted in the double-passed optical path between the beam dividing element (beam splitter (BS1)) 2 and the second mirror (MR2) 5.

The other one of the two beams divided by the beam diving element (beam splitter (BS1)) 2 is reflected by the first mirror (MR1) 4 and recombined by the beam diving element (beam splitter (BS1)) 2.

The recombined beam formed by the beam diving element (beam splitter (BS1)) 2 is divided into two mutually perpendicular polarized components by the second beam dividing element (polarizing beam splitter (PBS1)) 6, and the outputs from the second beam dividing element (polarizing beam splitter (PBS1)) 6 are respectively received by the first photodetector (PD1) 7 and the second photodetector (PD2) 8.

The first photodetector (PD1) 7 and the second photodetector (PD2) 8 that have received the respective beams provide signal outputs in such a manner that, as shown in FIG. 1A, the signal output PD1 from the first photodetector (PD1) 7 is π/2 phase-shifted from the signal output PD2 from the second photodetector (PD2) 8.

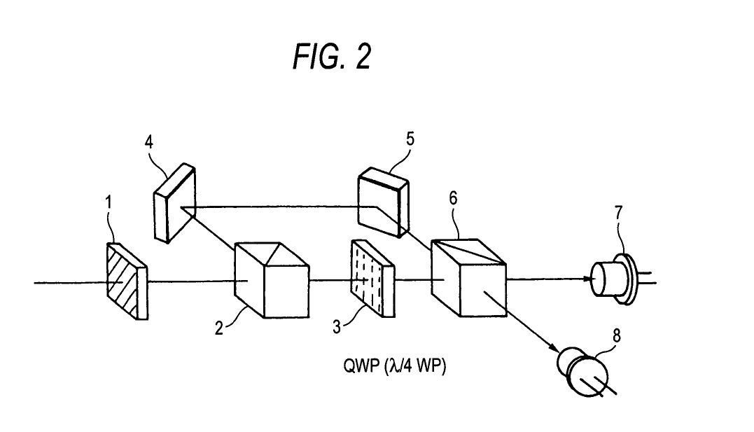

The construction of a second embodiment of a wavelength monitor according to the invention will be described with reference to FIG. 2.

In FIG. 2, reference numeral 1 denotes a 45-degree polarizer (POLL), reference numeral 2 denotes a beam splitter (BS1) which is a beam dividing element, reference numeral 3 denotes a λ/4 wave plate (λ/4 WP), reference numeral 4 denotes a first mirror (MR1), reference numeral 5 denotes a second mirror (MR2), reference numeral 6 denotes a polarizing beam splitter (PBS1), reference numeral 7 denotes a first photodetector (PD1), and reference numeral 8 denotes a second photodetector (PD2).

Incidentally, the periods of two amplitude signals are determined by their optical path difference, and the phase difference between the two signals is determined by the phase difference (thickness) of a wave plate.

Since the period, Δλ, of each of the amplitude signals is equal to λ²/optical path difference (ΔL), for example, the following expression is obtained:

200 pm=1550 nm/12 mm.

In the above-described construction, light exiting from a tunable laser source which is not shown is formed into a linearly polarized beam with a polarizing angle of 45 degrees by the polarizer (POL1) 1, and the beam transmitted through the polarizer (POL1) 1 is divided into two beams by the beam dividing element (beam splitter (BS1)) 2. One of the two beams is reflected by the first mirror (MR1) 4 and further reflected by the second mirror (MR2) 5, and is given to the polarizing beam splitter 6.

The other one of the two beams divided by the beam dividing element (beam splitter (BS1)) 2 is given to the polarizing beam splitter 6 via the λ/4 wave plate (λ/4 WP) 3.

The two beams given to the polarizing beam splitter 6 are recombined and divided into two mutually perpendicular polarized components, and the outputs from the polarizing beam splitter 6 are respectively received by the first photodetector (PD1) 7 and the second photodetector (PD2) 8.

The first photodetector (PD1) 7 and the second photodetector (PD2) 8 that have received the respective beams provide signal outputs in such a manner that, similarly to the case shown in FIG. 1A, the signal output PD1 from the first photodetector (PD1) 7 is π/2 phase-shifted from the signal output PD2 from the second photodetector (PD2) 8.

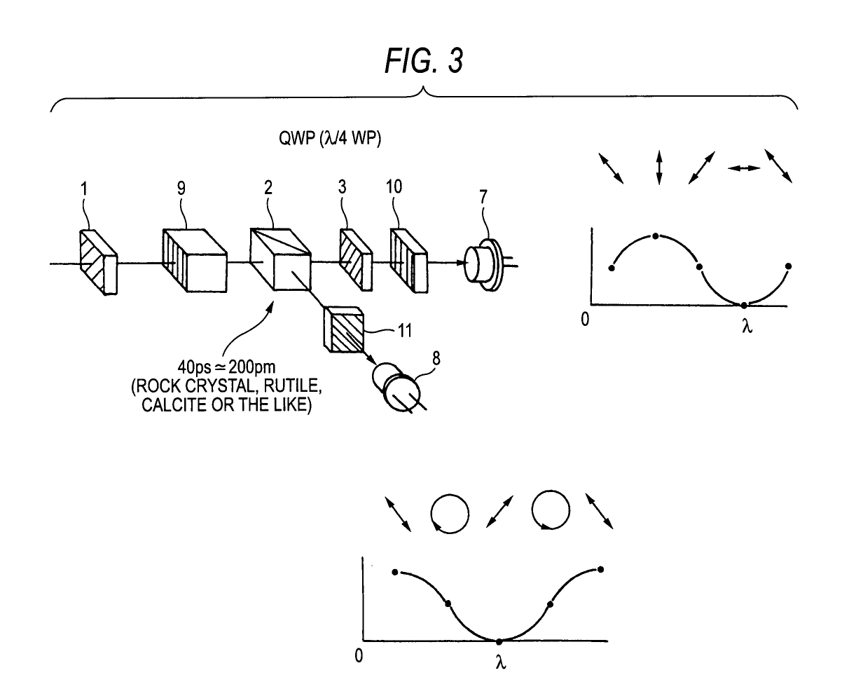

The construction of a third embodiment of a wavelength monitor according to the invention will be described with reference to FIG. 3.

In FIG. 3, reference numeral 1 denotes a first 45-degree polarizer (POL1), reference numeral 2 denotes a beam splitter (BS1) which is a beam dividing element, reference numeral 3 denotes a λ/4 wave plate (λ/4 WP), reference numeral 7 denotes a first photodetector (PD1), reference numeral 8 denotes a second photodetector (PD2), reference numeral 9 denotes a delay plate, reference numeral 10 denotes a second polarizer (POL2), and reference numeral 11 denotes a third polarizer (POL3).

Incidentally, the delay plate 9 can be ma de of rock crystal, rutile, calcite or the like.

In addition,

optical path difference (ΔL)=λ²/period (Δλ) of amplitude signal, and

delay plate thickness (t)=ΔL/diffractive index difference (Δn) of delay plate.

Oblique or vertical lines shown on one side of each of the polarizers, the wave plates and the delay plate illustrated in FIGS. 1 to 3 represent a crystal-axis direction.

In the above-described construction, light exiting from a tunable laser source which is not shown is formed into a linearly polarized beam with a polarizing angle of 45 degrees by the first polarizer (POL1) 1, and the beam transmitted through the polarizer (POL1) 1 is divided into two beams by the beam dividing element (beam splitter (BS1)) 2 via the delay plate (DL) 9. One of the two beams is given to the first photodetector (PD1) 7 via the λ/4 wave plate (λ/4 WP) 3 and the second polarizer (POL2) 10.

The other one of the two divided beams is given to the second photodetector (PD2) 8 via the third polarizer (POL3) 11.

The first photodetector (PD1) 7 and the second photodetector (PD2) 8 that have received the respective beams provide signal outputs in such a manner that, as shown in FIG. 1A, the signal output PD1 from the first photodetector (PD1) 7 is π/2 phase-shifted from the signal output PD2 from the second photodetector (PD2) 8.

The polarized state of each of the two output beams is as shown above 0, π/2, π, 3π/2 and 2π of the phase of the corresponding one of the waveforms shown in FIG. 3.

A motor control circuit which constitutes a tunable laser source according to the invention will be described below.

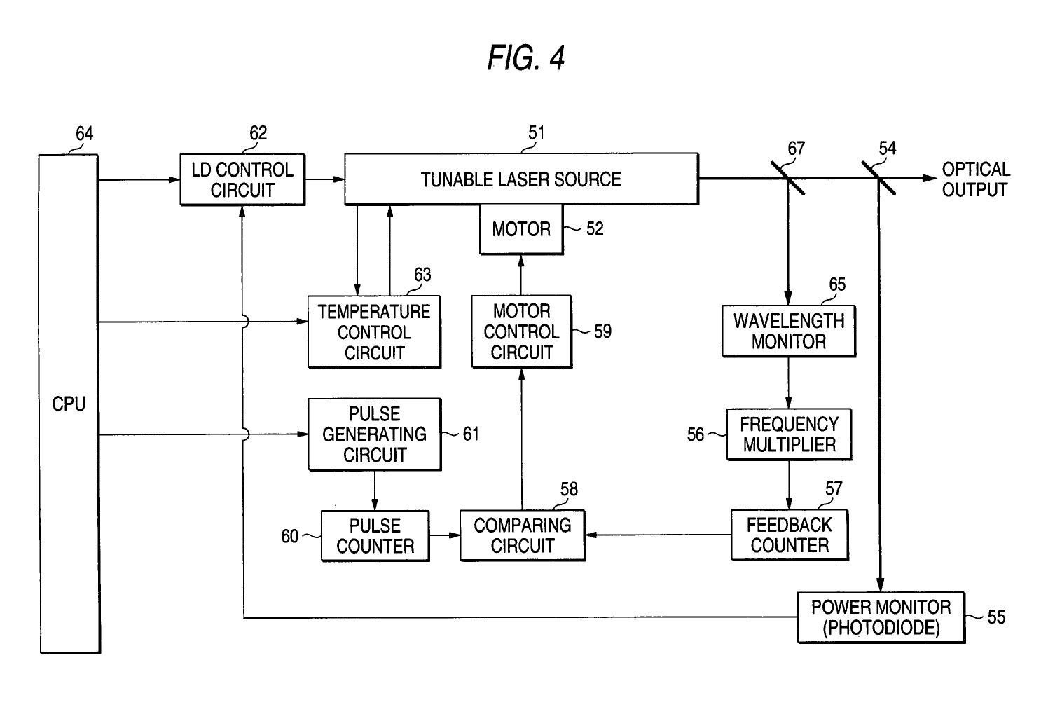

FIG. 4 is a block diagram showing an example of a construction for controlling a motor of a light source part according to the invention.

A motor (such as a servo motor) 52 which is wavelength varying means for a light source part 51 of a tunable laser source is controlled by a motor control circuit 59 according to the output of a comparing circuit 58.

The output light from the light source part 51 is divided into two beams by a beam splitter 67, and one of the two beams is applied to one input of the comparing circuit 58 via a wavelength monitor 65, a frequency multiplier 56 and a feedback counter 57, while the output from a pulse generating circuit 61 that responds to a control signal sent from a control CPU 64 is applied to the other input of the comparing circuit 58 as a comparing input via the pulse counter 60. In this manner, a feedback system is formed.

The output light from the tunable laser source part 51 is divided into two beams by a beam splitter 54, and one of the two beams is fed back to an LD control circuit 62 via a power monitor 55 formed by a photodiode or the like, and power control is performed so that the power of the output light from the tunable laser source part 51 becomes a set value sent from the CPU 64.

Further, the tunable laser source part 51 is temperature-controlled by a temperature control circuit 63 so that the temperature of the light source part 51 becomes a set value sent from the CPU 64.

In the motor control circuit shown in FIG. 4, the detected output of each of the wavelength monitors shown in FIGS. 1A to 3 (the first output signal PD1 is π/2 phase-shifted from the second signal output PD2) is converted into a digital signal corresponding to the wavelength of output light by the frequency multiplier 56, and is given to the comparing circuit 58 via the feedback counter 57, whereby the response speed of the motor which is the wavelength varying means can be improved.

Incidentally, in the motor control circuit of the invention shown in FIG. 4, the motor which serves as an actuator may be a servo motor or a stepping motor.

According to a first aspect of the invention, a wavelength monitor for detecting a wavelength variation of light outputted from a tunable laser source includes: a first polarizer for forming light outputted from the tunable laser source into a linearly polarized beam with a polarizing angle of 45 degrees; a beam splitter for dividing a beam transmitted through the polarizer into two beams; first reflecting means for reflecting one of the two beams divided by the beam splitter and causing the reflected one to again enter the beam splitter; a wave plate for performing λ/8 phase-shifting, the wave plate allowing the other of the two beams divided by the beam splitter to double-pass through the wave plate by being reflected by a second reflecting plate and causing the other to enter the beam splitter; and a polarizing beam splitter for dividing output light recombined by the beam splitter into two mutually perpendicular components, and outputting the respective components to first and second photodetectors, whereby the wavelength variation of the tunable laser source can be detected highly accurately and highly stably.

According to a second aspect of the invention, a wavelength monitor for detecting a wavelength variation of light outputted from a tunable laser source includes: a first polarizer for forming light outputted from the tunable laser source into a linearly polarized beam with a polarizing angle of 45 degrees; a beam splitter for dividing a beam transmitted through the polarizer into two beams; a polarizing beam splitter and first and second reflecting means for recombining the beams divided by the beam splitter, separating the recombined beams into two mutually perpendicular polarized components, and outputting the respective components to first and second photodetectors as output light; and a wave plate for performing λ/4 phase-shifting, the wave plate being inserted in either one of optical paths divided by the beam splitter, whereby it is possible to realize highly accurate and highly stable detection of the wavelength variation of the tunable laser source.

According to a third aspect of the invention, a wavelength monitor for detecting a wavelength variation of light outputted from a tunable laser source includes: a first polarizer for forming light outputted from the tunable laser source into a linearly polarized beam with a polarizing angle of 45 degrees; a delay unit for vectorially decomposing light outputted from the first polarizer and delaying one of components with respect to the other; a beam splitter for dividing light passed through the delay unit into two beams; a first photodetector for receiving one of the two beams divided by the beam splitter via a λ/4 phase-shifting wave plate and a second polarizer; and a second photodetector for receiving the other of the two beams divided by the beam splitter via a third polarizer, whereby it is possible to realize highly accurate and highly stable detection of the wavelength variation of the tunable laser source.

In a fourth aspect of the invention, a polarization maintaining fiber (PMF) may also be used in place of the first polarizer.

In a fifth aspect of the invention, an additional beam splitter is inserted after the first polarizer to execute power-monitoring of divided beams outputted from the additional beam splitter, whereby far more stable output light can be obtained.

According to a sixth aspect of the invention, a motor control device for driving a motor which is means for varying a wavelength of output light of a tunable laser source includes: a wavelength monitor for monitoring part of the output light of the tunable laser source and detecting wavelength information; a frequency multiplier for converting two π/2 phase-shifted periodical amplitude signals sent from the wavelength monitor into a digital signal corresponding to a wavelength of the output light; and a comparing circuit for finding a deviation between an output of the frequency multiplier and a command value, the motor control device driving and controlling the motor according to a comparison deviation outputted from the comparing circuit, whereby it is possible to realize a motor control device capable of easily highly precisely driving the motor which is wavelength varying means, by using any of the above-described wavelength monitors.

According to a seventh aspect of the invention, the tunable laser source is controlled to a constant level of power by power-monitoring for monitoring power of the output light of the tunable laser source. Therefore, more stable output light can be obtained by the tunable laser source.

What is claimed is:

1. A wavelength monitor for detecting a wavelength variation of light outputted from a tunable laser source, comprising:
a first polarizer for forming light outputted from the tunable laser source into a linearly polarized beam with a polarizing angle of 45 degrees;
a beam splitter for dividing a beam transmitted through the polarizer into two beams;
first reflecting means for reflecting one of the two beams divided by the beam splitter and causing the reflected one to again enter the beam splitter;
a wave plate for performing λ/8 phase-shifting, the wave plate allowing the other of the two beams divided by the beam splitter to double-pass through the wave plate by being reflected by a second reflecting plate and causing the other to enter the beam splitter; and
a polarizing beam splitter for dividing output light recombined by the beam splitter into two mutually perpendicular components, and outputting the respective components to first and second photodetectors.

2. A wavelength monitor for detecting a wavelength variation of light outputted from a tunable laser source, comprising:
a first polarizer for forming light outputted from the tunable laser source into a linearly polarized beam with a polarizing angle of 45 degrees;
a beam splitter for dividing a beam transmitted through the polarizer into two beams;
a polarizing beam splitter and first and second reflecting means for recombining the beams divided by the beam splitter, separating the recombined beams into two mutually perpendicular polarized components, and outputting the respective components to first and second photodetectors as output light; and
a wave plate for performing λ/4 phase-shifting, the wave plate being inserted in either one of optical paths divided by the beam splitter.

3. A wavelength monitor for detecting a wavelength variation of light outputted from a tunable laser source, comprising:
a first polarizer for forming light outputted from the tunable laser source into a linearly polarized beam with a polarizing angle of 45 degrees;
a delay unit for vectorially decomposing light outputted from the first polarizer and delaying one of components with respect to the other;
a beam splitter for dividing light passed through the delay unit into two beams;
a first photodetector for receiving one of the two beams divided by the beam splitter via a λ/4 phase-shifting wave plate and a second polarizer; and
a second photodetector for receiving the other of the two beams divided by the beam splitter via a third polarizer.

4. A wavelength monitor according to any one of claims 1 to 3, wherein a polarization maintaining fiber is used in place of the first polarizer.

5. A wavelength monitor according to any one of claims 1 to 3, wherein an additional beam splitter is inserted after the first polarizer to execute power-monitoring of divided beams outputted from the additional beam splitter.

6. A motor control device for driving a motor which is means for varying a wavelength of output light of a tunable laser source, comprising:
a wavelength monitor for monitoring part of the output light of the tunable laser source and detecting wavelength information;
a frequency multiplier for converting two π/2 phase-shifted periodical amplitude signals sent from the wavelength monitor into a digital signal corresponding to a wavelength of the output light; and
a comparing circuit for finding a deviation between an output of the frequency multiplier and a command value,
the motor control device driving and controlling the motor according to a comparison deviation outputted from the comparing circuit.

7. A motor control device according to claim 6, wherein the tunable laser source is controlled to a constant level of power by power-monitoring for monitoring power of the output light of the tunable laser source.
